(19) United States
(12) Patent Application Publication
(10) Pub. No.: US 2025/0369524 A1
(43) Pub. Date: Dec. 4, 2025

(54) Proportional Regulating Valve

(71) Applicant: Illinois Tool Works Inc., Glenview, IL (US)

(72) Inventors: Jian Wang, Shanghai (CN); Jing Cheng, Shanghai (CN); Zhigeng Wei, Shanghai (CN); Jingyi Wang, Shanghai (CN); Li Liu, Shanghai (CN)

(21) Appl. No.: 19/220,416

(22) Filed: May 28, 2025

(30) Foreign Application Priority Data
May 30, 2024 (CN) 202410687805.1

(51) Int. Cl. F16K 11/085

(52) U.S. Cl. CPC F16K 11/0856

(57) ABSTRACT

The present disclosure discloses a proportional regulating valve, including: a housing, a valve core, and a sealing device. The sealing device and the valve core are configured such that an effective operating angle of the valve core is greater than the sum of respective central angles of two housing outlets of the at least two housing outlets, and the effective operating angle of the valve core is an angle of rotation that enables the valve core outlet to be in communication with both of the two housing outlets and that changes the opening degree of at least one of the housing outlets. In the proportional regulating valve of the present disclosure, the opening degree adjustment range of the housing outlet is enlarged by setting the sizes of the inner side sealing opening and the valve core outlet to be larger than the size of the housing outlet, so that the opening degree of the housing outlet is more accurately adjusted while maintaining the size of the valve core and the total angle of rotation unchanged, thereby allowing more accurate regulation of proportions of flow between the housing inlet and the housing outlets, and between the housing outlets.

### RELATED APPLICATION

The present application claims the benefit of Chinese Patent Application Nos. 202410687805.1, filed May 30, 2024, titled “Proportional Regulating Valve,” the contents of which are hereby incorporated by reference.

### TECHNICAL FIELD

The present disclosure relates to regulating valves, and in particular to a proportional regulating valve.

### BACKGROUND

Regulating valves include a housing and a valve core which is movably arranged in the housing. The housing is provided with a housing outlet. In general, the valve core can perform linear or rotational movement, and the valve core can adjust the opening degree of the housing outlet with its movement, to adjust the flow rate of the housing outlet. When the housing is provided with a plurality of housing outlets, adjusting the opening degrees of these housing outlets can regulate a proportion of flow between the housing outlets.

### SUMMARY OF THE DISCLOSURE

The present disclosure relates generally to a proportional regulating valve, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a structural perspective view of a proportional regulating valve according to an embodiment of the present disclosure from one perspective.

FIG. 1B is an exploded view of the proportional regulating valve shown in FIG. 1A from another perspective.

FIG. 2A is a front view of the proportional regulating valve shown in FIG. 1A with an actuator and an actuator mounting seat removed.

FIG. 2B is a cross-sectional view of the proportional regulating valve shown in FIG. 2A taken along line A-A.

FIG. 2C is an exploded view of the proportional regulating valve shown in FIG. 2A from one perspective.

FIG. 3A is a front view of a valve core in FIG. 2C.

FIG. 3B is a cross-sectional view of the valve core shown in FIG. 3A taken along line C-C.

FIG. 3C is a cross-sectional view of the valve core shown in FIG. 3A taken along line D-D.

FIG. 4A is a structural perspective view of a sealing device in FIG. 2C.

FIG. 4B is a cross-sectional view of the sealing device shown in FIG. 4A.

FIG. 4C is an exploded view of the sealing device shown in FIG. 4A.

FIGS. 5A-5C show an opening degree adjustment process of a housing outlet of the proportional regulating valve during the rotation of the valve core.

### DETAILED DESCRIPTION OF EMBODIMENTS

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein is not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent to or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure provides a proportional regulating valve, including: a housing, a valve core, and a sealing device. The housing defines a mounting cavity, and has at least two housing outlets. The valve core is arranged inside the mounting cavity and rotatable about an axis, the valve core includes a circumferential side wall extending in a circumferential direction of the valve core, the circumferential side wall having a valve core blocking wall and a valve core outlet, and the valve core is configured to be capable of adjusting the opening degrees of the at least two housing outlets by means of the valve core blocking wall and the valve core outlet with the rotation of the valve core, so as to regulate a proportion of flow between the at least two housing outlets. The sealing device is connected inside the housing and located between the valve core and the housing, and the sealing device includes at least two sealing cavities, the at least two sealing cavities being arranged corresponding to the at least two housing outlets, where each of the sealing cavities forms an inner side sealing opening in an inner surface of the sealing device, and the opening degree of the inner side sealing opening is the same as the opening degree of the corresponding housing outlet. The sealing device and the valve core are configured such that an effective operating angle of the valve core is greater than the sum of respective central angles of two housing outlets of the at least two housing outlets, and the effective operating angle of the valve core is an angle of rotation that enables the valve core outlet to be in communication with both of the two housing outlets and that changes the opening degree of at least one of the housing outlets.

According to the above content, each of respective dimensions of the inner side sealing opening and the valve core outlet in a circumferential direction is larger than a respective dimension of each of the housing outlets.

According to the above content, each of the sealing cavities is provided with an outer side sealing opening in an outer surface of the sealing device, and the outer side sealing opening, the inner side sealing opening and the valve core outlet have the same respective dimensions in a circumferential direction.

According to the above content, each of the housing outlets has an opening degree in a range from 0 to 100%, and each of the sealing cavities has a radial dimension set to be not less than 60% of a diameter of a corresponding housing outlet.

According to the above content, the sealing device includes a first sealing member and a second sealing member that are connected to each other, the second sealing member being arranged inside of the first sealing member, where the first sealing member is made of a rigid material, and the second sealing member is made of a flexible material.

According to the above content, the first sealing member is made of a plastic material, and/or the second sealing member is made of a rubber material.

According to the above content, the first sealing member has at least two first sealing windows, the second sealing member has at least two second sealing windows, and the first sealing windows match are arranged and aligned with the second sealing windows, so as to cooperatively form the at least two sealing cavities, where the second sealing windows have the inner side sealing openings.

According to the above content, the first sealing member and the second sealing member are configured to be detachably engaged with each other.

According to the above content, the first sealing member has an engagement portion protruding inwardly, and the engagement portion includes a circumferential flange and an axial ridge, where the circumferential flange is arranged at an edge of at least one of the first sealing windows, and protrudes from the outside to the inside and extends circumferentially; and the axial ridge is arranged between the at least two first sealing windows and protrudes from the outside to the inside and extends axially. Moreover, the second sealing member has a receiving portion engaging with the engagement portion, and the receiving portion includes a circumferential groove and an axial notch, where the circumferential groove is arranged at an edge of a corresponding second sealing window, and is recessed from the outside to the inside and extends circumferentially, so as to engage the circumferential flange; and the axial notch is arranged between the at least two second sealing windows and axially penetrates through the second sealing member, so as to allow two ends of the second sealing member at the axial notch to be engaged on two opposite sides of the axial ridge.

According to the above content, the sealing device further includes an additional sealing strip, the additional sealing strip being arranged on an outer wall of the first sealing member around the first sealing windows, and the additional sealing strip being configured to be capable of abutting against an inner wall of the housing.

According to the above content, the housing has a housing inlet. The valve core has a valve core inlet and a valve core channel, the valve core channel being in fluid communication with the valve core inlet and the valve core outlet, and the circumferential dimension of the valve core inlet is configured to enable the valve core inlet to fluidly communicate with the housing inlet with the rotation of the valve core.

According to the above content, the valve core includes an upper valve core and a lower valve core, the valve core inlet is arranged in the upper valve core, the lower valve core has the circumferential side wall, and the sealing device is arranged around the circumferential side wall of the lower valve core.

According to the above content, the valve core includes a rotating shaft, the rotating shaft having the axis, where the rotating shaft is capable of being driven by an actuator to rotate.

According to the above content, the valve core further includes a valve core sealing strip, the valve core sealing strip being arranged on an outer wall of the circumferential side wall, and the valve core sealing strip being configured to be capable of abutting against an inner wall of the sealing device.

The concept, specific structures and resulting technical effects of the present disclosure will be further described below with reference to the accompanying drawings so as to fully understand the objective, features and effects of the present disclosure.

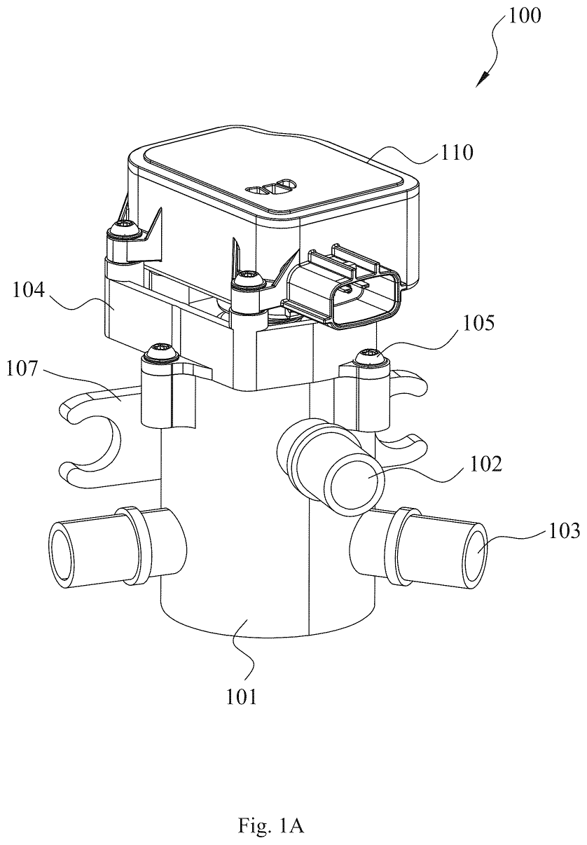

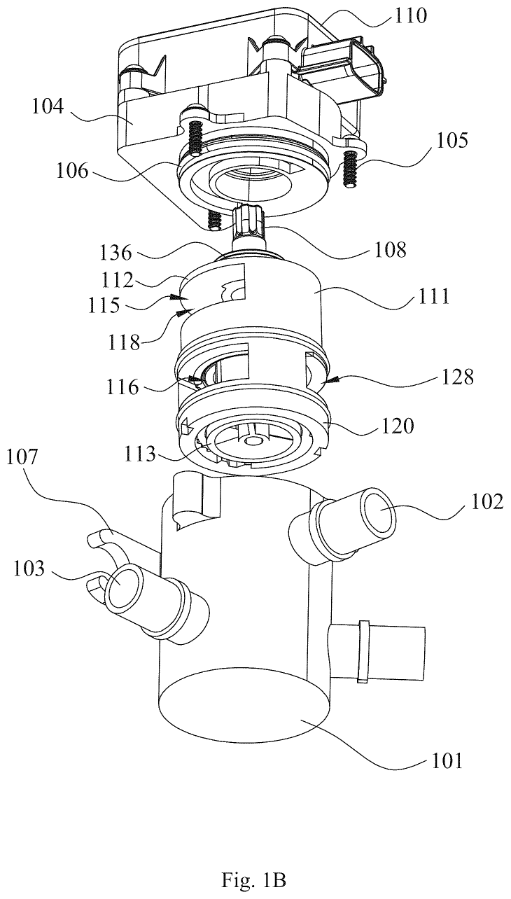

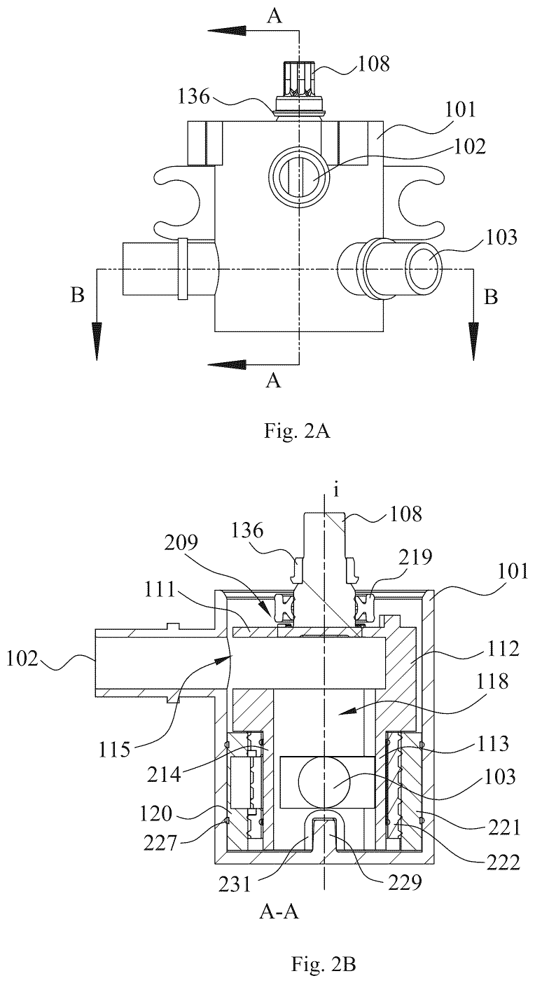

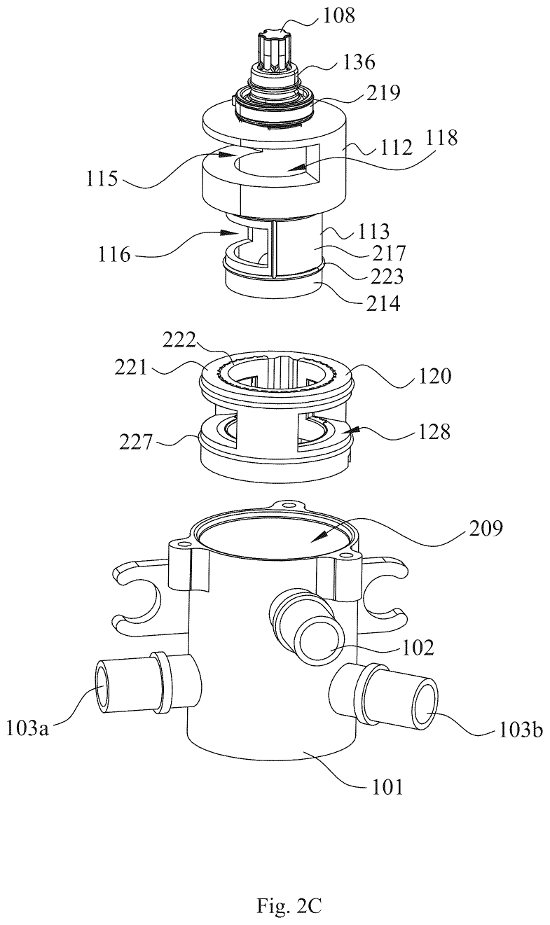

FIGS. 1A and 1B show the general structure of a proportional regulating valve 100 according to an embodiment of the present disclosure, for explaining the external structure and the general components of the proportional regulating valve 100. FIG. 1A is a perspective view of the proportional regulating valve 100 when viewed from above, and FIG. 1B is an exploded view of the proportional regulating valve 100 when viewed from below. As shown in FIGS. 1A and 1B, the proportional regulating valve 100 includes a housing 101, an actuator 110, and an actuator mounting seat 104. The actuator 110 is mounted on top of the housing 101 via the actuator mounting seat 104. The housing 101 defines a mounting cavity 209 therein (see FIG. 2B), and the housing 101 has a housing inlet 102 and two housing outlets 103 that are in communication with the mounting cavity 209. In this embodiment, the housing inlet 102 is arranged above the two housing outlets 103, and the two housing outlets 103 are arranged at substantially the same height.

The proportional regulating valve 100 further includes a valve core 111. The valve core 111 is arranged in the mounting cavity 209. The top of the valve core 111 passes through the actuator mounting seat 104 and is engaged with the actuator 110 such that the valve core 111 can be driven by the actuator 110 to rotate. With the rotation of the valve core 111, the valve core 111 can fluidly communicate the housing inlet 102 with one or both of the two housing outlets 103 and regulate a proportion of flow between the two housing outlets 103 by adjusting the opening degree of the two housing outlets 103. In this embodiment, the opening degree of the housing outlet 103 ranges from 0 to 100%. When the opening degree of the housing outlet 103 is 0, the housing outlet 103 is closed; and when the opening degree of the housing outlet 103 is 100%, the housing outlet 103 is fully opened.

The proportional regulating valve 100 further includes a sealing device 120. The sealing device 120 is arranged between the valve core 111 and the housing 101 to ensure the sealing performance of the valve core 111 during the process of communicating the housing inlet 102 with the housing outlet 103. The sealing device 120 is connected to an inner side of the housing 101, and the valve core 111 rotates relative to the sealing device 120.

Specifically, the actuator mounting seat 104 is securely connected to the top of the housing 101 via a number of bolts 105. The bottom of the actuator mounting seat 104 has an annular sealing ring 106. The annular sealing ring 106 is sealingly connected between the housing 101 and the actuator mounting seat 104 to prevent leakage of a fluid from the interior of the housing 101. A rotating shaft 108 at the top of the valve core 111 passes from below through the actuator mounting seat 104, and extends into engagement with the actuator 110, such that the actuator 110 can drive the valve core 111 to rotate about an axis of the rotating shaft 108. In this embodiment, a sealing ring 136 is sleeved on the rotating shaft 108. The sealing ring 136 is configured to abut between the actuator mounting seat 104 and the rotating shaft 108 when the rotating shaft 108 passes through the actuator mounting seat 104, to prevent the fluid from entering the actuator 110. It will be appreciated by those skilled in the art that in some embodiments, in addition to the sealing ring 136, a sealing member 219 (see FIG. 2B) is also sleeved on the rotating shaft 108 to achieve a better sealing connection between the rotating shaft 108 and the actuator mounting seat 104.

The valve core 111 is generally in the shape of a cylinder, which has an axially-extending valve core channel 118. The valve core 111 includes an upper valve core 112 and a lower valve core 113. An outer diameter of the upper valve core 112 is greater than that of the lower valve core 113. The valve core channel 118 is in fluid communication with the lower valve core 113 and the upper valve core 112. The valve core channel 118 has a valve core inlet 115 and a valve core outlet 116. The valve core inlet 115 is arranged on the upper valve core 112, and the valve core outlet 116 is arranged on the lower valve core 113. The circumferential dimension of the valve core inlet 115 is configured to enable the valve core inlet 115 to fluidly communicate with the housing inlet 102 during the rotation of the valve core 111. The circumferential dimension of the valve core outlet 116 is configured to enable the valve core outlet 116 to fluidly communicate with one or both of the two housing outlets 103, or to prevent the valve core outlet 116 from fluidly communicating with the housing outlet 103 during the rotation of the valve core 111.

The sealing device 120 is arranged around the lower valve core 113 and is disposed between the housing 101 and the lower valve core 113. The sealing device 120 has sealing cavities 128 arranged corresponding to the housing outlets 103, each sealing cavity 128 surrounding the respective housing outlet 103. The valve core outlet 116 is or is not in sealing communication with the housing outlet 103 through the corresponding sealing cavity 128. In this embodiment, a circumferential dimension of the sealing cavity 128 is larger than a circumferential dimension of the housing outlet 103, so that the sealing cavity 128 can enlarge the circumferential dimension of the corresponding housing outlet 103, so as to more accurately adjust the opening degree of the housing outlet 103 when the angle of rotation of the valve core 111 is constant, and to more accurately regulate the proportion of flow between the two housing outlets 103 when the valve core 111 is in communication with both of the two housing outlets 103. In the present disclosure, an effective operating angle of the valve core 111 may be greater than the sum of respective central angles of the two housing outlets 103. The effective operating angle of the valve core here is an angle of rotation that enables the valve core outlet 116 to be in communication with both of the two housing outlets 103 and that changes the opening degree of at least one of the housing outlets 103. Moreover, in the present disclosure, more accurate adjustment means that the rate of change of the flow rate per unit angle of rotation of the valve core 111 driven by the actuator 110 is smaller, resulting in a higher accuracy of adjustment.

It will be appreciated by those skilled in the art that in other embodiments, more housing outlets may be provided, or the housing outlets may be arranged at different heights, as long as the valve core outlet of the valve core is provided accordingly. The housing 101 is further provided with a mounting plate 107. The proportional regulating valve 100 can be mounted to other components of a vehicle by means of the mounting plate 107.

FIGS. 2A-2C show the structure of the proportional regulating valve 100 with the actuator 110 and the actuator mounting seat 104 removed, for illustrating more specific components and engaging structures of the proportional regulating valve 100. FIG. 2A shows a front view of the proportional regulating valve 100, FIG. 2B shows a cross-sectional view of the proportional regulating valve 100 of FIG. 2A taken along the line A-A, and FIG. 2C shows an exploded view of the proportional regulating valve 100 of FIG. 2A when viewed from below. As shown in FIGS. 2A-2C, the housing 101 is in the shape of a cylinder with an open top, and the actuator mounting seat 104 can close the open top of the housing 101. An inwardly-protruding securing shaft 229 is provided in the bottom of the housing 101. The securing shaft 229 is configured to connect to the valve core 111 and limit the position thereof. The housing outlets 103 include a housing outlet 103a and a housing outlet 103b at the same height.

The valve core 111 is rotatably arranged in the mounting cavity 209 of the housing 101. The top of the valve core 111 has the rotating shaft 108 for engagement with the actuator 110, and the bottom of the valve core 111 has a receiving sleeve 231 for receiving the securing shaft 229 at the bottom of the housing 101. The rotating shaft 108 and the securing shaft 229 have a common axis i to enable the valve core 111 to rotate about the axis i under the drive of the actuator 110. The rotating shaft 108 passes beyond the top of the housing 101. The sealing ring 219 and the sealing ring 136 are sleeved on the rotating shaft 108. The sealing ring 219 is sleeved on the rotating shaft 108 at a position below the top of the housing 101 to form a seal between the rotating shaft 108 and the housing 101 to prevent leakage of the fluid from the interior of the housing 101. As described above, the sealing ring 136 is sleeved on the rotating shaft 108 at a position above the top of the housing 101 for forming a seal between the rotating shaft 108 and the actuator mounting seat 104. In this way, the fluid entering the interior of the housing 101 from the housing inlet 102 can only flow out of the housing outlet 103.

The valve core channel 118 of the valve core 111 extends longitudinally to communicate the valve core inlet 115 located at the upper valve core 112 with the valve core outlet 116 located at the lower valve core 113. The outer diameter of the upper valve core 112 is greater than the outer diameter of the lower valve core 113. The total outer diameter of the lower valve core 113 and the sealing device 120 is substantially the same as the outer diameter of the upper valve core 112, and both are substantially the same as an inner diameter of the housing 101. Specifically, the upper valve core 112 has a circumferentially-extending opening to form the valve core inlet 115. The height of the valve core inlet 115 is substantially the same as the height of the housing inlet 102, so that the fluid, after entering the interior of the housing 101 from the housing inlet 102, can pass through the valve core inlet 115 into the valve core channel 118. The valve core channel 118 extends longitudinally through the bottom of the lower valve core 113 from the opening of the valve core inlet 115. The lower valve core 113 has a circumferential side wall 214. The circumferential side wall 214 has the valve core outlet 116 and a valve core blocking wall 217. In this embodiment, the circumferential side wall 214 has a circumferentially-extending opening to form the valve core outlet 116, the height of the valve core outlet 116 being the same as the height of the housing outlet 103. The portion of the circumferential side wall 214 that has no opening within the height range of the valve core outlet 116 forms the valve core blocking wall 217. The valve core outlet 116 can communicate the sealing cavity 128 with the corresponding housing outlet 103, and the valve core blocking wall 217 can at least partially block the sealing cavity 128 from the corresponding housing outlet 103, so that the valve core outlet 116 and the valve core blocking wall 217 can cooperatively adjust the opening degree of the two housing outlets 103 with the rotation of the valve core 111, so as to regulate the proportion of flow between the two housing outlets 103.

In this embodiment, the sealing device 120 includes a first sealing member 221 and a second sealing member 222. The first sealing member 221 and the second sealing member 222 are connected to each other, and the second sealing member 222 is arranged inside of the first sealing member 221. The first sealing member 221 is in sealing contact with and fixedly connected to the housing 101, and the second sealing member 222 is in sealing contact with and rotates relative to the valve core 111. In some embodiments, the second sealing member 222 has a better sealing performance with respect to the first sealing member 221. In some embodiments, first sealing member 221 is made of a rigid material, such as plastic, so that the sealing device 120 has a better strength. The second sealing member 222 is made of a flexible material, such as rubber, to meet the requirement of seal between the sealing device 120 and the valve core 111. In some embodiments, the first sealing member 221 and the second sealing member 222 are configured to be detachably engaged with each other, to facilitate replacement of the second sealing member 222. It will be appreciated by those skilled in the art that in some embodiments, it is also possible that the sealing device 120 does not include two sealing members, but rather is integrally formed, or that the first sealing member and the second sealing member are not made of a rigid material and a flexible material, respectively, as long as the sealing device can meet the requirements of strength and sealing performance.

In this embodiment, the valve core 111 further includes a valve core sealing strip 223. The valve core sealing strip 223 is arranged on an outer wall of the circumferential side wall 214 of the valve core 111 for abutting against an inner wall of the sealing device 120. The sealing device 120 further includes an additional sealing strip 227. The additional sealing strip 227 is arranged on an outer wall of the first sealing member 221 for abutting against an inner wall of the housing 101. In some embodiments, the valve core sealing strip 223 and the additional sealing strip 227 are both made of a flexible material such as rubber material. By providing the valve core sealing strip 223 and the additional sealing strip 227, a better sealing effect can be provided between the housing 101, the sealing device 120 and the valve core 111.

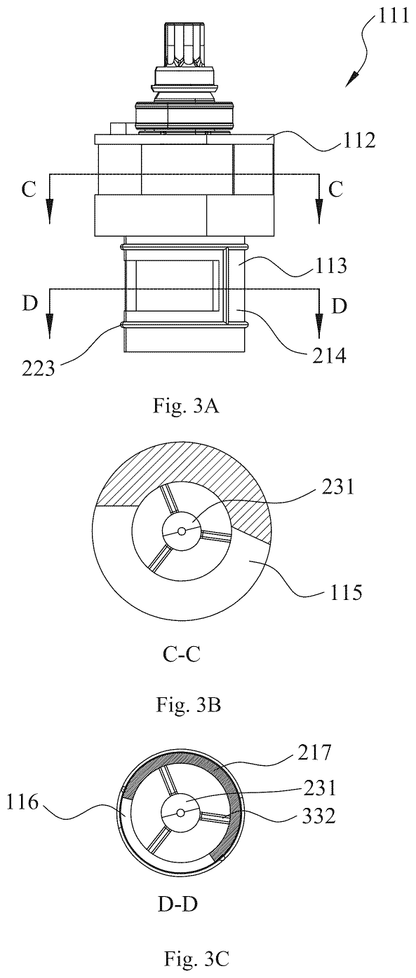

FIGS. 3A-3C show the specific structure of the valve core 111. FIG. 3A shows a front view of the valve core 111. FIG. 3B shows a cross-sectional view of the valve core 111 of FIG. 3A taken along line C-C, showing the structure of the upper valve core 112. FIG. 3C shows a cross-sectional view of the valve core 111 of FIG. 3A taken along line D-D, showing the structure of the lower valve core 113. As shown in FIGS. 3A-3C, the upper valve core 112 is in the shape of a cylinder with its top closed, and the valve core inlet 115 extends circumferentially on a cylindrical wall of the upper valve core 112. The central angle corresponding to the circumferential dimension of the valve core inlet 115 is substantially the same as the angle of rotation of the valve core 111, such that the valve core inlet 115 maintains in fluid communication with the housing inlet 102 with the rotation of the valve core 111. In some embodiments, the angle of rotation of the valve core 111 ranges from 200 to 210°, and the central angle corresponding to the circumferential dimension of the valve core inlet 115 is set to 200 to 210° accordingly.

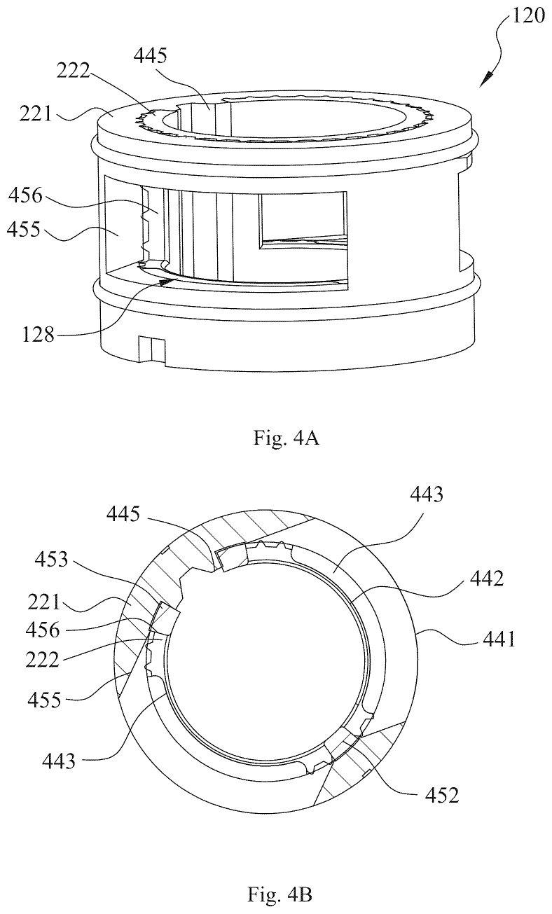

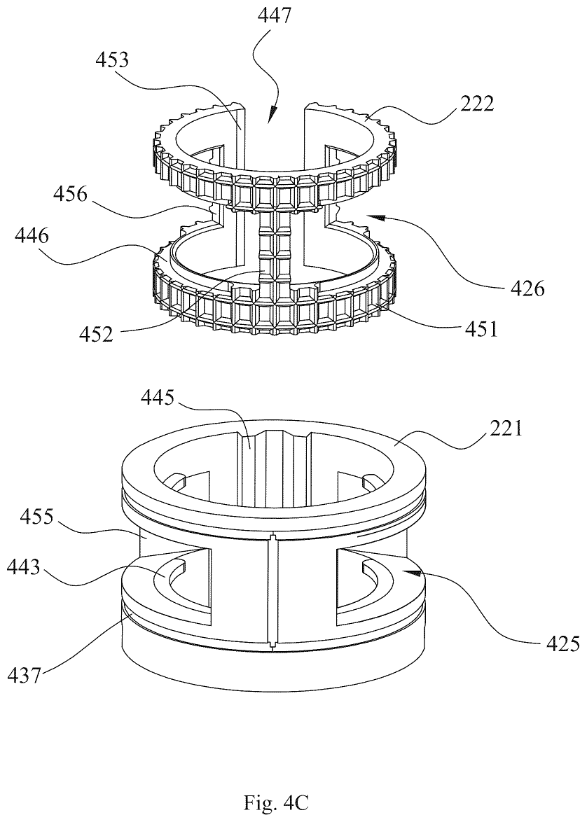

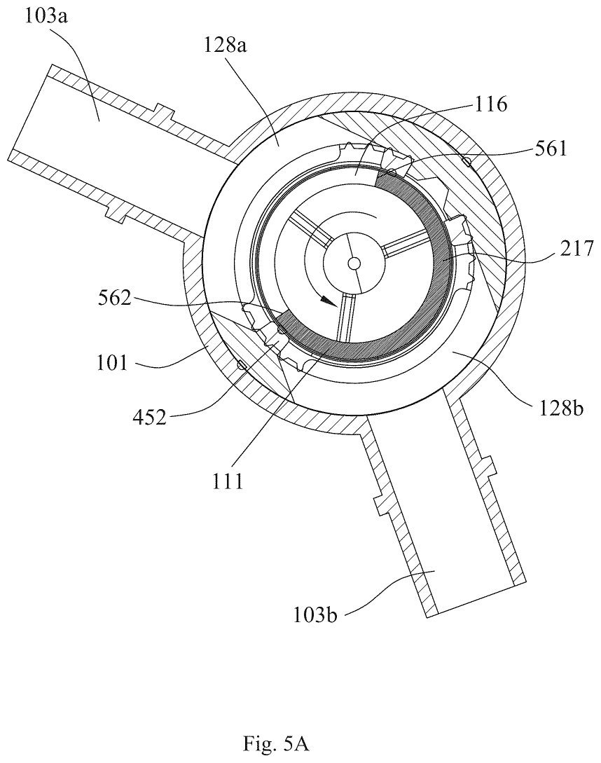

The lower valve core 113 is also in the shape of a cylinder, with a hollow interior portion. A cylindrical wall of the lower valve core 113 forms the circumferential side wall 214. The top of the lower valve core 113 is connected to the bottom of the upper valve core 112, and the bottom of the lower valve core 113 is opened. The receiving sleeve 231 of the lower valve core 113 is connected at the center of the lower valve core 113 via a number of support rods 332 to facilitate connecting the valve core 111 to the housing 101 at a proper position. In some embodiments, the bottom of the lower valve core 113 may also be configured in other shapes, as long as it can be connected to the housing 101 at a proper position. The valve core outlet 116 extends circumferentially on the circumferential side wall 214 of the lower valve core 113 to form the valve core outlet 116 and the valve core blocking wall 217 on the circumferential side wall 214. The circumferential dimension of the valve core outlet 116 is substantially the same as the circumferential dimension of the inner side sealing opening 442 (see FIG. 4B) of the sealing cavity 128 of the sealing device 120, such that upon rotation of the valve core 111 to the position where the valve core outlet 116 is aligned with the sealing cavity 128, the sealing cavity 128 does not impede the fluid from flowing out of the valve core outlet 116, and the opening degree of the housing outlet 103 is thus 100%. The valve core sealing strip 223 is arranged on an outer wall of the lower valve core 113 around the valve core outlet 116 to provide better seal between the lower valve core 113 in the vicinity of the valve core outlet 116 and the sealing device 120. In some embodiments, the valve core sealing strip 223 includes a circumferentially-extending portion surrounding the valve core outlet 116, and an axially-extending portion.

The valve core channel 118 extends longitudinally from the upper valve core 112 to the lower valve core 113, and has the same cross-sectional area in the upper valve core 112 as in the lower valve core 113. That is, the flow area of the fluid flowing in the valve core channel 118 does not change. Since the outer diameter of the upper valve core 112 is larger than the outer diameter of the lower valve core 113, the constant cross-sectional area of the valve core channel 118 will make the wall thickness of the upper valve core 112 greater than the wall thickness of the lower valve core 113.

FIGS. 4A-4C show the specific structure of the sealing device 120. FIG. 4A shows a structural perspective view of the sealing device 120 of FIG. 2C. FIG. 4B shows a cross-sectional view of the sealing device 120 of FIG. 4A taken along line D-D in FIG. 3A. FIG. 4C shows an exploded view after the additional sealing strip 227 has been removed and the first sealing member 221 and the second sealing member 222 of the sealing device 120 have been separated. As shown in FIGS. 4A-4C, an inner wall of the first sealing member 221 has an engagement portion, and the second sealing member 222 has a receiving portion corresponding with the engagement portion. By engaging the engagement portion with the receiving portion, the first sealing member 221 and the second sealing member 222 can be detachably engaged with each other.

Specifically, the first sealing member 221 is in the shape of a circular ring, which has two spaced-apart first sealing windows 425 on a side wall thereof, each of the first sealing windows 425 penetrating through the side wall of the first sealing member 221, to form part of the sealing cavity 128. The engagement portion of the first sealing member 221 includes a circumferential flange 443 and an axial ridge 445. The circumferential flange 443 is arranged at an edge of each first sealing window 425 and protrudes from the outside to the inside and extends circumferentially. The axial ridge 445 is arranged on an inner wall of the side wall of the first sealing member 221, is located between the two first sealing windows 425, protrudes inwardly, and extends axially. The outer wall of the first sealing member 221 has an accommodating groove 437. The accommodating groove 437 is configured to accommodate the additional sealing strip 227. In this embodiment, the accommodating groove 437 includes a circumferentially-extending groove surrounding each of the first sealing windows 425, and an axially-extending groove, such that the additional sealing strip 227 can provide a better seal between the first sealing member 221 and the housing 101.

The second sealing member 222 is also in the shape of a circular ring, which has two spaced-apart second sealing windows 426 and a connecting portion 452 on a side wall thereof. The two second sealing windows 426 are arranged on opposite sides of the connecting portion 452 in a circumferential direction. Each of the second sealing windows 426 penetrates through the side wall of the second sealing member 222. The two second sealing windows 426 are arranged and aligned with the two first sealing windows 425, such that the respective first sealing windows 425 and second sealing windows 426 cooperatively form the sealing cavities 128. The receiving portion of the second sealing member 222 includes a circumferential groove 446 and an axial notch 447. The circumferential groove 446 is provided at an edge of each second sealing window 426, and is recessed from the outside to the inside and extends circumferentially, so as to engage the circumferential flange 443 of the first sealing member 221. The axial notch 447 is provided on the side wall of the second sealing member 222 and extends axially through the second sealing member 222 from top to bottom, and the axial notch 447 is located between the two second sealing windows 426. The axial notch 447 forms two end portions 453 on the second sealing member 222 in the shape of a circular ring, the two end portions 453 being respectively engaged on opposite sides of the axial ridge 445 of the first sealing member 221. In this way, the circumferential flange 443 of the first sealing member 221 engages with the circumferential groove 446 of the second sealing member 222, to prevent axial displacement of the first sealing member 221 relative to the second sealing member 222. The axial ridge 445 of the first sealing member 221 engages with the axial notch 447 of the second sealing member 222, to prevent rotation of the first sealing member 221 relative to the second sealing member 222.

A pair of side walls 455 of each first sealing window 425 are arranged substantially in parallel, each side wall 455 extending obliquely to a radial direction. A pair of side walls 456 of each second sealing window 426 are arranged substantially in parallel and aligned with the pair of side walls 455 of the corresponding first sealing window 425. In this embodiment, an outer surface of the side wall 456 of each second sealing window 426 abuts against an inner surface of the side wall 455 of the corresponding first sealing window 425. This facilitates the machining and assembly of the first sealing member 221 and the second sealing member 222.

In some embodiments, the second sealing member 222 has a number of ribs 451 on the outer wall thereof. The ribs 451 can facilitate the machining and manufacturing of the second sealing member 222, such as in demolding processes. Moreover, since the second sealing member 222 is made of a flexible material, the ribs 451 can be deformed to provide better seal between the first sealing member 221 and the second sealing member when the first sealing member 221 is engaged with the second sealing member 222.

In the present disclosure, the sealing device 120 has a thickness such that the sealing cavity 128 can have a volume and the fluid in the sealing cavity 128 thus has a flow rate, to avoid fluid interception. In this embodiment, the sealing cavity 128 of the sealing device 120 has a radial dimension set to be not less than 60% of the diameter of the corresponding housing outlet 103. Since the sealing cavity 128 is provided penetrating through the first sealing member 221 and the second sealing member 222, the radial dimension of the sealing cavity 128 is the overall thickness of the sealing device 120. That is, the overall thickness of the sealing device 120 is set not less than 60% of the diameter of the corresponding housing outlet 103. The greater the overall thickness of the sealing device 120 is, the smaller the outer diameter of the corresponding lower valve core 113 will be when the outer diameter of the upper valve core 112 and the inner diameter of the housing 101 are constant. In order to ensure the size of the valve core channel 118, the lower valve core 113 also will have a smaller thickness. Those skilled in the art can set the thickness of the sealing device 120 according to specific requirements.

Each sealing cavity 128 of the sealing device 120 forms an outer side sealing opening 441 and an inner side sealing opening 442, respectively, on the outer surface of the first sealing member 221 and the inner surface of the second sealing member 222. In this embodiment, each outer side sealing opening 441 is formed by outer edges of the pair of side walls 455 of each first sealing window 425, and the outer side sealing opening 441 is configured to be in sealing contact with the housing 101 and is provided around the housing outlet 103 at an outer periphery of the housing outlet 103. Each inner side sealing opening 442 is formed by inner edges of the pair of side walls 456 of each second sealing window 426, and the inner side sealing opening 442 is configured to be in sealing contact with the valve core 111. With the rotation of the valve core 111, the inner side sealing opening 442 can be aligned with the valve core opening 116, or at least partially closed by the valve core blocking wall 217, to adjust the opening degree of the inner side sealing opening 442. The opening degree of the inner side sealing opening 442 affects the flow rate of the fluid from the valve core outlet 116 into the sealing cavity 128 and, in turn, the flow rate out of the housing outlet 103. When the inner side sealing opening 442 is aligned with the valve core opening 116, the opening degree of the inner side sealing opening 442 is 100% and the opening degree of the corresponding housing outlet 103 is also 100%. When the valve core blocking wall 217 blocks the inner side sealing opening 442, the opening degree of the inner side sealing opening 442 is 0%, and the opening degree of the corresponding housing outlet 103 is 0%. In this way, the opening degree adjustment range of the housing outlet 103 can be increased from the central angle corresponding to the housing outlet 103 to the central angle corresponding to the inner side sealing opening 442. During the process of communicating the valve core outlet 116 with both of the two housing outlets 103, the range of the angle of rotation that changes the opening degree of one of the housing outlets 103 is also increased accordingly. In some embodiments, the circumferential dimensions of the connecting portion 452 and the axial notch 447 are set as small as possible to maximize the circumferential dimension of the inner side sealing opening 442.

In this embodiment, the circumferential dimensions of the outer side sealing opening 441 and the inner side sealing opening 442 are substantially the same. Moreover, the circumferential dimensions of the outer side sealing opening 441 and the inner side sealing opening 442 are the same as the circumferential dimension of the valve core outlet 116 of the valve core 111. The circumferential dimensions being substantially the same here means that the outer side sealing opening 441, the inner side sealing opening 442 and the valve core outlet 116 have corresponding shapes and are substantially aligned with one another at the edges thereof. This enables a better sealing effect without affecting the flow area of the fluid. In order to more accurately adjust the flow rate of the housing outlet, the circumferential dimensions of the inner side sealing opening 442, the outer side sealing opening 441 and the valve core outlet 116 can be set to be as large as possible. However, since the second sealing member 222 is arranged on the inner side of the first sealing member 221, when the circumferential dimension of the inner side sealing opening 442 is too large, the circumferential dimensions of the connecting portion 452 and the axial notch 447 of the second sealing member 222 are relatively small, and the circumferential dimension of the corresponding axial ridge 445 is relatively small. Those skilled in the art can set their circumferential dimensions according to specific requirements. When the shape and the size of the second sealing window 426 of the second sealing member 222 are determined, the shapes and the sizes of the valve core outlet and the first sealing window 425 are set according to the specific shape.

It will be appreciated by those skilled in the art that in some embodiments, the outer side sealing opening and the inner side sealing opening do not need to have the same size, as long as it can be ensured that the overall thickness of the sealing device and the circumferential dimension of the inner side sealing opening are greater than the circumferential dimension of the valve core outlet.

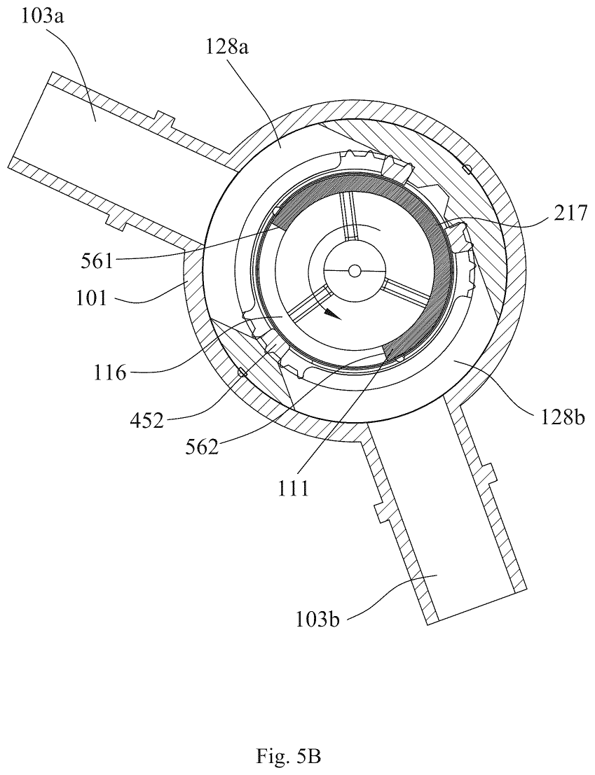

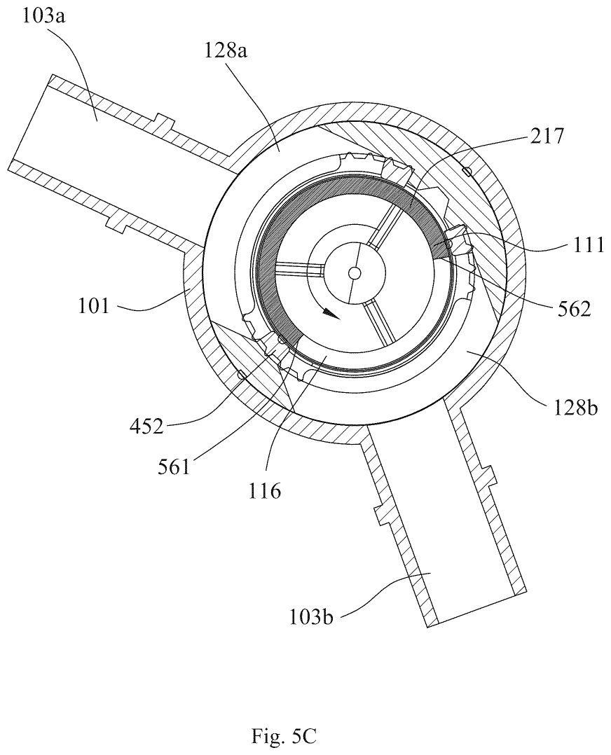

FIGS. 5A-5C show the opening degree adjustment process of the housing outlet of the proportional regulating valve during the rotation of the valve core 111. The housing outlet 103a is arranged corresponding to the sealing cavity 128a, and the housing outlet 103b is arranged corresponding to the sealing cavity 128b. FIG. 5A shows the state of the proportional regulating valve in which the housing outlet 103a is fully opened and the housing outlet 103b is closed. FIG. 5B shows the state of the proportional regulating valve in which the housing outlet 103a and the housing outlet 103b are both opened. FIG. 5C shows the state of the proportional regulating valve in which the housing outlet 103a is closed and the housing outlet 103b is fully opened.

FIGS. 5A-5C show the structure of the proportional regulating valve after being cut along B-B in FIG. 2A. The valve core 111 can rotate counterclockwise from FIG. 5A through FIG. 5B to FIG. 5C, and clockwise from FIG. 5C through FIG. 5B to FIG. 5A.

Specifically, as shown in FIG. 5A, the valve core 111 rotates to a position where the valve core outlet 116 is aligned with the sealing cavity 128a such that the sealing cavity 128a is fully opened, and the opening degree of the housing outlet 103a is 100%. The valve core blocking wall 217 blocks the sealing cavity 128b such that the sealing cavity 128b is completely closed and the opening degree of the housing outlet 103b is 0. In this case, the valve core inlet 115 maintains in fluid communication with the housing inlet 102 such that all the fluid entering the proportional regulating valve 100 from the housing inlet 102 flows out of the housing outlet 103a.

As the valve core 111 rotates counterclockwise, one end of the valve core blocking wall 217 (the downstream end in the direction of rotation, hereinafter referred to as the downstream end 561) starts to move toward the sealing cavity 128a such that the sealing cavity 128a is partially closed, and the opening degree of the housing outlet 103a starts to decrease. Moreover, one end of the valve core blocking wall 217 (the upstream end in the direction of rotation, hereinafter referred to as the upstream end 562) starts to move past the connecting portion 452 and moves toward the sealing cavity 128b such that the sealing cavity 128b starts to be in fluid communication with the valve core outlet 116, the sealing cavity 128b starts to be opened, and the opening degree of the housing outlet 103b starts to increase. The valve core inlet 115 maintains in fluid communication with the housing inlet 102 such that part of the fluid entering the proportional regulating valve 100 from the housing inlet 102 starts to flow out of the housing outlet 103a and the other part of the fluid flows out of the housing outlet 103b until the valve core 111 reaches the position shown in FIG. 5B.

As shown in FIG. 5B, the valve core blocking wall 217 blocks part of the sealing cavity 128a and the valve core outlet 116 opens the other part of the sealing cavity 128a such that the sealing cavity 128a is not fully opened, and the opening degree of the housing outlet 103a is substantially 50%. Moreover, the valve core outlet 116 opens part of the sealing cavity 128b, and the valve core blocking wall 217 blocks the other part of the sealing cavity 128b, such that the sealing cavity 128b is not fully opened, and the opening degree of the housing outlet 103b is substantially 50%. The valve core inlet 115 maintains in fluid communication with the housing inlet 102 such that part of the fluid entering the proportional regulating valve 100 from the housing inlet 102 flows out of the housing outlet 103a and the other part of the fluid flows out of the housing outlet 103b. As the valve core 111 rotates counterclockwise, the valve core 111 reaches the position shown in FIG. 5C.

As shown in FIG. 5C, the downstream end 561 of the valve core blocking wall 217 starts to abut against the connecting portion 452 such that the valve core blocking wall 217 completely blocks the sealing cavity 128a, the sealing cavity 128a is completely closed, and the opening degree of the housing outlet 103a is substantially 0. Moreover, the valve core outlet 116 is aligned with the sealing cavity 128b such that the sealing cavity 128b is fully opened and the opening degree of the housing outlet 103b is substantially 100%. In this case, the valve core inlet 115 maintains in fluid communication with the housing inlet 102 so that all the fluid entering the proportional regulating valve 100 from the housing inlet 102 flows out of the housing outlet 103b.

In this way, when the valve core 111 rotates from the position shown in FIG. 5A to the position shown in FIG. 5C, the opening degree of the housing outlet 103a decreases from 100% to 0, and the opening degree of the housing outlet 103b increases from 0 to 100%. When the flow rate of the fluid entering the proportional regulating valve 100 from the valve core inlet 115 is constant, the different opening degree of the housing outlet 103a and the housing outlet 103b will cause the fluid to flow out at different flow rates.

In the proportional regulating valve of the present disclosure, the opening degree adjustment range of the housing outlet is increased by setting the sizes of the inner side sealing opening and the valve core outlet to be larger than the size of the housing outlet, so that the opening degree of the housing outlet is more accurately adjusted under the condition that the size of the valve core and the total angle of rotation are unchanged, thereby allowing more accurate regulation of proportions of flow between the housing inlet and the housing outlets, and between the individual housing outlets.

The sealing device in the present disclosure includes two parts connected to each other, and by configuring the two parts to be made of different materials, not only can the sealing requirements of the sealing device be met, but the strength requirements can also be met.

In addition, the proportional regulating valve of the present disclosure can achieve a more accurate flow range by configuring the specific structures of the sealing device and the valve core, without the need for changing the external dimensions of the housing and a connecting duct thereof.

Although the present disclosure is described with reference to the examples of the embodiments outlined above, various alternatives, modifications, variations, improvements and/or substantial equivalents, which are known or can be anticipated at present or to be anticipated before long, may be obvious to those of at least ordinary skill in the art. Accordingly, the examples of the embodiments of the present disclosure as set forth above are intended to be illustrative rather than limiting. Various changes may be made without departing from the spirit or scope of the present disclosure. Therefore, the present disclosure is intended to encompass all known or earlier disclosed alternatives, modifications, variations, improvements, and/or substantial equivalents. The technical effects and technical problems in this specification are exemplary rather than limiting. It should be noted that the embodiments described in this specification may have other technical effects and can solve other technical problems.

What is claimed is:

1. A proportional regulating valve, comprising:
a housing defining a mounting cavity, the housing having at least two housing outlets;
a valve core arranged inside the mounting cavity and rotatable about an axis, the valve core comprising a circumferential side wall extending in a circumferential direction of the valve core, the circumferential side wall having a valve core blocking wall and a valve core outlet, and the valve core being configured to be capable of adjusting the opening degrees of the at least two housing outlets by means of the valve core blocking wall and the valve core outlet with the rotation of the valve core, so as to regulate a proportion of flow between the at least two housing outlets; and
a sealing device connected inside the housing and located between the valve core and the housing, the sealing device comprising at least two sealing cavities, the at least two sealing cavities being arranged corresponding to the at least two housing outlets, wherein each of the sealing cavities forms an inner side sealing opening in an inner surface of the sealing device, and the opening degree of the inner side sealing opening is the same as the opening degree of the corresponding housing outlet;
wherein the sealing device and the valve core are configured such that an effective operating angle of the valve core is greater than the sum of respective central angles of two housing outlets of the at least two housing outlets, and wherein the effective operating angle of the valve core is an angle of rotation that enables the valve core outlet to be in communication with both of the two housing outlets and that changes the opening degree of at least one of the housing outlets.

2. The proportional regulating valve according to claim 1, wherein each of respective dimensions of the inner side sealing opening and the valve core outlet in a circumferential direction is larger than a respective dimension of each of the housing outlets.

3. The proportional regulating valve according to claim 1, wherein each of the sealing cavities is provided with an outer side sealing opening in an outer surface of the sealing device, and the outer side sealing opening, the inner side sealing opening and the valve core outlet have the same respective dimensions in a circumferential direction.

4. The proportional regulating valve according to claim 1, wherein each of the housing outlets has an opening degree in a range from 0 to 100%, and each of the sealing cavities has a radial dimension set to be not less than 60% of a diameter of a corresponding housing outlet.

5. The proportional regulating valve according to claim 1, wherein the sealing device comprises a first sealing member and a second sealing member that are connected to each other, the second sealing member being arranged inside of the first sealing member, wherein the first sealing member is made of a rigid material, and the second sealing member is made of a flexible material.

6. The proportional regulating valve according to claim 5, wherein the first sealing member is made of a plastic material, and/or the second sealing member is made of a rubber material.

7. The proportional regulating valve according to claim 5, wherein the first sealing member has at least two first sealing windows, the second sealing member has at least two second sealing windows, and the first sealing windows are arranged and aligned with the second sealing windows, so as to cooperatively form the at least two sealing cavities, wherein the second sealing windows have the inner side sealing openings.

8. The proportional regulating valve according to claim 7, wherein the first sealing member and the second sealing member are configured to be detachably engaged with each other.

9. The proportional regulating valve according to claim 7, wherein the first sealing member has an engagement portion protruding inwardly, and the engagement portion comprises a circumferential flange and an axial ridge, wherein the circumferential flange is arranged at an edge of at least one of the first sealing windows, and protrudes from the outside to the inside and extends circumferentially; and the axial ridge is arranged between the at least two first sealing windows and protrudes from the outside to the inside and extends axially; and
the second sealing member has a receiving portion engaging with the engagement portion, and the receiving portion comprises a circumferential groove and an axial notch, wherein the circumferential groove is arranged at an edge of a corresponding second sealing window, and is recessed from the outside to the inside and extends circumferentially, so as to engage the circumferential flange; and the axial notch is arranged between the at least two second sealing windows and axially penetrates through the second sealing member, so as to allow two ends of the second sealing member at the axial notch to be engaged on two opposite sides of the axial ridge.

10. The proportional regulating valve according to claim 7, wherein the sealing device further comprises an additional sealing strip, the additional sealing strip being arranged on an outer wall of the first sealing member around the first sealing windows, and the additional sealing strip being configured to be capable of abutting against an inner wall of the housing.

11. The proportional regulating valve according to claim 1,
wherein the housing has a housing inlet; and
wherein the valve core has a valve core inlet and a valve core channel, the valve core channel being in fluid communication with the valve core inlet and the valve core outlet, and the circumferential dimension of the valve core inlet is configured to enable the valve core inlet to fluidly communicate with the housing inlet with the rotation of the valve core.

12. The proportional regulating valve according to claim 11, wherein the valve core comprises an upper valve core and a lower valve core, the valve core inlet is arranged in the upper valve core, the lower valve core has the circumferential side wall, and the sealing device is arranged around the circumferential side wall of the lower valve core.

13. The proportional regulating valve according to claim 1, wherein the valve core comprises a rotating shaft, the rotating shaft having the axis, wherein the rotating shaft is capable of being driven by an actuator to rotate.

14. The proportional regulating valve according to claim 1, wherein the valve core further comprises a valve core sealing strip, the valve core sealing strip being arranged on an outer wall of the circumferential side wall, and the valve core sealing strip being configured to be capable of abutting against an inner wall of the sealing device.
